(19) United States
(12) Patent Application Publication
(10) Pub. No.: US 2025/0288478 A1
(43) Pub. Date: Sep. 18, 2025

(54) SAFETY SYSTEM FOR DETECTING ERRORS IN MEDICAL TABLES

(71) Applicant: MAQUET GMBH, Rastatt (DE)

(72) Inventors: Andreas Puder, Rastatt (DE); Rodrigo DEL ALCAZAR VON BUCHWALD, Waldbronn (DE)

(21) Appl. No.: 18/862,419

(22) PCT Filed: May 3, 2023
(86) PCT No.: PCT/EP2023/061649

§ 371 Date: Nov. 1, 2024

(30) Foreign Application Priority Data
May 3, 2022 (DE) 10 2022 110 888.0

(51) Int. Cl. A61G 13/02

(52) U.S. Cl. CPC A61G 13/02; A61G 2203/32; A61G 2203/36; A61G 2203/42; A61G 2203/70

(57) ABSTRACT

A system for detecting an error of a sensor in an operating table and/or an error when determining a load or a load center, comprising: an operating table with an adjustable patient bearing surface for bearing a patient; a load sensor arrangement with several load sensors which issue sensor values; a load determination unit which determines at least one of the following first sizes with the sensor values: a load, a center of the load, a speed of the load center and an acceleration of the load center, wherein the load is a load acting on the load sensor arrangement or a load acting on the operating table or a total load of the operating table; a calculation unit which predicts or calculates at least one expected second size; and an error recognition unit which compares the sensor values or the at least one first size with the at least one second size and, if the deviation exceeds a predetermined value, detects an error and/or a possible error.

The present application claims the priority of the German patent application no. 10 2022 110 888.0, submitted at the German Patent and Trademark Office on 3 May 2022. The disclosure content of the German patent application no. 10 2022 110 888.0 is herewith incorporated in the disclosure content of the present application.

### TECHNICAL FIELD

The present disclosure relates to medial and surgical tables where the table plate and/or segments of the table plate are movable. In particular, it relates to systems which can detect errors which can occur in medical tables. The errors can be errors of sensors, for example, which are integrated in the tables, or errors which occur during determination of a load or a load center.

### BACKGROUND OF THE DISCLOSURE

Operating tables serve to bear a patient, for example during a surgical intervention. At present, nurses and doctors have to consider many important aspects due to the flexibility when setting up the operating table, the number of accessory parts and the different possibilities of positioning the patient the operating table offers, in order to be able to use the operating table correctly. Some of these aspects are listed below:
The equipment used should be adapted to the weight of the patient.
The configuration of the equipment should also be adapted to the weight of the patient.
The patient bearing surface on which the patient is located should be displaced within allowable limits only.
If a movement restriction applies, it should be made sure that the allowable limits are at no time exceeded.
When adjusting the operating table, it should be made sure that the operating table does not collide with an external object, e.g. a C-arm.
Furthermore, when adjusting the operating table, it should be made sure that the patient is correctly secured and does not fall or slide from the operating table.

Important information on the points mentioned above are listed in the user manual of the operating table. If the user ignores the user manual or does not pay enough attention to collisions and the patient, the following dangerous events can occur:
Tipping of the operating table: Fall of the patient which can lead to lasting injuries or even death.
Overload of structural parts of the accessories and of the operating table: This can result in the structural parts bending permanently or breaking or causing lasting injuries or even the death of the patient.
Overload of the motorized joints: Causes a limited mobility as the operating table is not able to move.
Collision of the operating table with an external object: During movement, the operating table can collide and damage expensive equipment, e.g. C-arms.
Fall of the patient: If the patient is not sufficiently secured, the patient can start to slide during table movements, which in the worst case can result in the patient falling to the ground.

Patient bearing surfaces of operating tables can have exchangeable, detachably connectable segments. Often, some or all of the exchangeable segments are movable. Through the use of different exchangeable segments, a single operating table can be reconfigured in different ways for different patients and medical procedures. Furthermore, individual segments or the complete patient bearing surface can be adjusted in different ways. For example, individual segments or the complete patient bearing surface can be trended or tilted or displaced in the longitudinal or lateral direction. However, this means that the size, shape, dimensions, weight and strength of the individual operating tables are different at different times. In order to be able to prevent a tipping of the operating table or an overload of individual structure parts or of the complete operating table, it should be known in which position the patient bearing surface and its segments are and which load acts on the patient bearing surface or the complete operating table and where the center of this load is. For this purpose, operating tables can have different sensors, which measure the force acting on the operating table, for example, or determine at which angles the patient bearing surface is trended or tilted or by which distance the patient bearing surface was deployed. Such sensors must be fail-safe, otherwise the safety of the patients cannot be guaranteed. If a sensor fails and delivers bad information, the system should notice this. Moreover, a user should be warned that particular systems are not reliable and the operating table is in a safety-critical condition. Further, certain functions of the operating table could be blocked and a movement of the operating table slowed down or stopped completely.

A solution to the described problem is to use a second set of redundant sensors. If one of the sensors should fail, this would be noticed by the second, redundant sensor.

However, redundant sensors are very expensive and often cannot be employed in the operating tables due to insufficient installation space.

Document S U.S. Pat. No. 11,058,325 B2 discloses a patient support device with a patient bearing surface, a primary sensor, several secondary sensors, a primary control and a secondary control. The primary sensor is a load sensor which measures forces which are applied to a component of the patient bearing surface. The primary control receives the force measurements from the primary sensor. The secondary sensors measure several secondary parameters which can influence the force measurements carried out by the primary sensor. The secondary sensors can contain a humidity sensor, a pressure sensor, a gyroscope, a magnetometer, an accelerometer, a speed sensor, a temperature sensor or an angle sensor. The secondary control processes the outputs of the secondary sensors in order to recognize whether the force applied to the component of the patient support device is outside a range of force values. U.S. Pat. No. 11,058,325 B2 does not disclose an operating table system as is disclosed here, which determines a load acting on the load sensor arrangement or the patient bearing surface, a center of the load, a speed of the load center or an acceleration of the load center as a first size and predicts or calculates another expected second size, wherein an error is detected if the two sizes differ too much.

Document U.S. Pat. No. 7,472,439 B2 discloses a patient bed which can be employed in hospitals. A diagnostic and control system can monitor or request the functions or the status of electronic elements such as load sensors. The diagnostic and control system can monitor the current status of the operating parameters of these electronic elements and compare the collected data with a set of standard operating characteristics. In this way, possible errors can be recognized if a particular electronic element is not working within a desired and/or predetermined range. U.S. Pat. No. 7,472,439 B2 does not disclose that an expected size which is compared to the operating parameters is calculated from the operating parameters of the electronic elements.

Document WO 2017003766 A1 describes a people bearing device. In the device, load sensors are integrated which are connected to a detection circuit. With the help of the detection circuit, it can be determined whether the load sensors work incorrectly. Two load sensors can be provided, which are respectively coupled to an activation line. An activation voltage source charges the two activation lines with a constant voltage. In an embodiment, a control monitors a total amount of electric current which flows from the activation voltage source to the activation lines. The control determines that one of the load sensors is in an error state if the total amount of electric current which flows from the activation voltage source to the activation lines lies outside a predetermined range. WO 2017003766 A1 does not disclose that a further expected size is calculated from the load or the load center determined with the help of load sensors and if the deviation of the calculated expected size from the determined load or the load center is too high, an error is determined.

### SUMMARY OF THE DISCLOSURE

It is an object of the present disclosure to provide a system which is advantageously designed to detect a faulty sensor in an operating table.

Additionally or alternatively, the system is to be embodied such that it detects an error which can occur when a load or a load center of the operating table is determined.

According to a first aspect of the present disclosure, a system is provided which is adapted to detect a faulty sensor in an operating table and/or to detect an error when a load or a load center is determined. The system can have an operating table with an adjustable patient bearing surface, a load sensor arrangement with several load sensors, a calculation unit and an error recognition unit.

The patient bearing surface of the operating table serves to bear a patient, for example during a surgical intervention. The patient bearing surface can be modularly formed and have a bearing surface main section which can be extended by coupling diverse bearing surface subsections. For this, the bearing surface main section and the bearing surface subsections can have mechanical connection elements with which the bearing surface main and subsections can be detachably connected. Bearing surface subsections can be leg or head sections, for example. Furthermore, the bearing surface subsections can also be extension or intermediate sections which are inserted between the bearing surface main section and the head section, for example.

The load sensors can issue sensor values from which a load acting on the load sensor arrangement and furthermore also a load acting on the patient bearing surface can be determined. The load acting on the load sensor arrangement can in particular comprise all external force sizes, i.e. forces and torques, acting of the load sensor arrangement. The load sensors can be force sensors, in particular weighing cells, for example, which respectively measure a force acting on the respective sensor. The force sensors can issue a respective electrical signal, for example an electrical voltage, as the output signal from which the respective measured force can be derived. Furthermore, it can also be provided that the force sensors issue the respective specific size of the respective force measured by them, e.g. in a digital form, as a sensor value.

It is further conceivable that the load sensor arrangement determines a resulting total force from the sensor values of the individual load sensors, wherein the resulting total force results from the individual forces acting on the different force sensors.

The load acting on the load sensor arrangement comprises, for example, the load caused by the components arranged above the load sensor arrangement and the load caused by the patient borne on the operating table or other objects located on the operating table. Further, a person can also cause a load on the operating table, for example by the person standing next to the operating table and supporting themselves on the operating table with a hand or another body part. Moreover, external forces created in another way can create a load on the operating table. Such loads can also be measured by the load sensor arrangement.

The load sensor arrangement can be arranged at different positions in the operating table. For example, the load sensor arrangement can be integrated into the column of the operating table. Furthermore, the load sensor arrangement can be arranged on or adjacent to interfaces which the column forms with the patient bearing surface or the foot (e.g. the base). Consequently, the load sensor arrangement can be arranged between the patient bearing surface and the column, for example. Alternatively, the load sensor arrangement can be arranged between the column and the foot, for example.

The load sensor arrangement can be integrated in the operating table so that the full load flows through the load sensor arrangement or is transmitted by it. In particular, the load which is caused above the load sensor arrangement can flow through the load sensor arrangement or be transmitted by it.

The load determination unit can be coupled to the load sensor arrangement and obtain the sensor values issued by the load sensors. With the sensor values, the load determination unit can determine at least one first size. i.e. exactly one or several first sizes. The first size can be a load, a center of the load, a speed of the load center or an acceleration of the load center. The load can be a load acting on the load sensor arrangement or a load acting on the operating table or a total load of the operating table.

The load acting on the load sensor arrangement can also be referred to as measuring load. The measuring load corresponds to the load which is created by all persons, objects and forces on the operating table above the load sensors. The measuring load corresponds to the load value which is measured by the load sensor arrangement.

The load acting on the operating table can be referred to as an active load and corresponds to the load which is caused by components which are not assigned to the operating table and persons and external forces and acts on the operating table. Components assigned to the operating table are components which are recognized by the operating table by means of a detection system, e.g. bearing surface sections or segments and/or other accessory parts. The active load does not take into account the influence of the components assigned to the operating table. Only the other components of the operating table contribute to the active load, i.e. the components which are not assigned to the operating table. These can be accessory parts, for example, which are not recognized by the operating table, or other objects which are placed on the operating table. Furthermore, the patient located on the operating table contributes to the active load. Moreover, all forces acting externally on the operating table, which are applied to the operating table by persons and/or objects outside the operating table for example, contribute to the active load.

The total load of the operating table is the load which results from the measuring load and from a load caused by components which are assigned to the operating table and are below the load sensor arrangement. Consequently, the total load considers loads from components which are located below the load sensor arrangement and cannot be measured by the load sensor arrangement and thus do not contribute to the measuring load. Consequently, the total load is the load which results from the complete operating table, the patient, the components assigned to the operating table, the components not assigned to the operating table and other external forces.

In conclusion, the at least one first size determined by the load determination unit can be selected from the following sizes:
the measuring load, the center of the measuring load, the speed of the center of the measuring load and the acceleration of the center of the measuring load;
the active load, the center of the active load, the speed of the center of the active load and the acceleration of the center of the active load; and
the total load, the center of the total load, the speed of the center of the total load and the acceleration of the center of the total load; and

The calculation unit can calculate or predict at least one expected second size. The at least one expected second size can be an estimated and/or predicted size and can be a time-dependent or time-independent expectation value. For example, the at least one expected second size can be directly calculated from the at least one first size or the at least one first size can first be subjected a further proceeding and the at least one expected second size can be calculated from the result of the further proceeding. It can be provided that the at least one expected second size is calculated or predicted after the at least one first size. But the at least one expected second size can also be calculated or predicted before the at least one first size. The terms “first size” and “second size” only serve to distinguish between the two sizes. It does not indicate which one of the two sizes is calculated, determined or predicted first.

In some designs, the calculation unit can only predict the at least one expected second size and in particular not calculate it. In some designs, the calculation unit can only calculate the at least one expected second size and in particular not predict it.

The error recognition unit can make a comparison between the values determined by the load sensor arrangement or the load determination unit and the expectation value determined by the calculation unit. For this, the error recognition unit can compare the sensor values or at least one first size determined by the load determination unit with the at least one expected second size. The at least one first size which is included in this comparison can be the at least one first size from which the at least one expected second size was calculated. But a first size determined by the load determination unit at another, in particular later time, for example, can also be used for the comparison with the at least one expected second size.

If the comparison reveals that the deviation of the at least one expected second size from the sensor values or the at least one first size exceeds a predetermined value, i.e. the difference between the at least one expected second size and the sensor values or the at least one first size is greater than the predetermined value, the error recognition unit can determine that there is an error and/or a possible error. The error can be a faulty sensor, i.e. a sensor not working correctly, or an error which occurs when the load or the load center is determined.

The error recognition unit enables to warn the user of the operating table when entering a safety-critical condition in order to guarantee the safety of the patient. Further, measures can be taken to avoid or prevent the safety-critical condition.

The system described here does not require a complete additional sensor set for detecting an error and does not necessarily required an additional hardware unit either. Both the calculation and the error recognition unit can be implemented as software functions. But it is also conceivable that the calculation and/or the error recognition unit are embodied as hardware units.

Furthermore, the calculation unit and/or the error recognition unit can either be integrated in the operating table or be located outside the operating table. One or both units can be integrated in the calculation unit, for example, which is outside the operating table and is connected to the operating table via radio or a fixed wiring, for example.

According to a second aspect of the present disclosure, the calculation unit, when the patient bearing surface is adjusted, can predict the load center changed by the adjustment as the at least one second size. Further, the load determination unit can determine the load center after adjustment of the patient bearing surface with the sensor values. The load center determined by the load determination unit after adjusting the patient bearing surface can be used by the error recognition unit as the at least one first size.

The error recognition unit can compare the center predicted by the calculation unit with the center determined by the load determination unit after adjusting the patient bearing surface. If the deviation of the center predicted by the calculation unit from the center determined by the load determination unit exceeds the predetermined value, the error recognition unit can detect an error and/or a possible error. As explained above, the error can be a faulty sensor, i.e. a sensor not working correctly, or an error which occurs when the load or the load center is determined.

The present design requires that the patient bearing surface is adjusted, only then an error can be detected. The patient bearing surface can be adjusted by trending or tilting the patient bearing surface, for example, or displacing it longitudinally or laterally. A trend of the patient bearing surface is also referred to as a Trendelenburg trend where the patient is borne so that the head of the patient is down and the pelvis of the patient is further up. An anti Trendelenburg trend is where the head of the patient is positioned high while the pelvis is further below. A tilt means that the patient bearing surface is trended to the side. During a longitudinal shift, the patient bearing surface is displaced along its longitudinal axis, while during a lateral shift, the patient bearing surface is displaced perpendicularly to its main axis.

The system can further have an optional condition estimation unit which determines an actual center of the load with the center predicted by the calculation unit and the center determined by the load determination unit.

In some designs, the inputs in the condition estimation unit, i.e. the center predicted by the calculation unit and the center determined by the load determination unit, can be weighted. For example, the center predicted by the calculation unit and the center determined by the load determination unit can form the load center estimated by the condition estimation unit in equal parts, i.e. 50% each. Other ratios between the center predicted by the calculation unit and the center determined by the load determination unit can be chosen as well. For example, it can be provided that the estimated load center corresponds to 100% of the center determined by the load determination unit. In this case, the prediction made by the calculation unit would not have any influence on the estimated actual load center.

The condition estimation unit can be a pure software function, but it can also be embodied as a hardware unit. Further, the condition estimation unit can be integrated in the operating table or be external to the operating table and be integrated in the calculation unit described above, for example.

The condition estimation unit can have a Kalman filter for estimating the actual load center. In particular, the Kalman filter can be an extended Kalman filter or an unscented Kalman filter.

The calculation unit, the load determination unit and the condition estimation unit can work iteratively. The condition estimation unit estimates the actual load center at the time t and the calculation unit predicts the load center at the time t+1 with the actual load center at the time t estimated by the condition estimation unit. Further, the load determination unit determines the load center at the time t+1. The condition estimation unit then estimates the actual load center at the time t+1 with the load center at the time t+1 predicted by the calculation unit and the load center at the time t+1 determined by the load determination unit.

The iterative method can be proceeded in the same way by the calculation unit predicting the load center at the time t+2 with the actual load center at the time t+1 estimated by the condition estimation unit and the condition estimation unit then estimating the actual load center at the time t+2 with the load center at the time t+2 predicted by the calculation unit and the load center at the time t+2 determined by the load determination unit.

The error recognition unit can detect an error and/or a possible error if a number of iterations was performed and the error recognition unit determined in at least N of the iterations that the center predicted by the calculation unit and the center determined by the load determination unit differ by more than the predetermined deviation. N can be a predetermined number.

Alternatively, the error recognition unit can detect an error and/or a possible error if the center predicted by the calculation unit and the center determined by the load determination unit exceed a predetermined deviation in at least one of the iterations. Consequently, an error is determined in this design as soon as the error recognition unit determines for the first time that the center predicted by the calculation unit and the center determined by the load determination unit differ by more than the predetermined deviation.

A third aspect of the present disclosure provides a system which is identical or similar to the system according to the second aspect in many aspects. The difference between both systems is that the system according to the third aspect uses the speed or the acceleration of the load center instead of the position of the load center. When the patient bearing surface is adjusted, the calculation unit can predict the speed or the acceleration of the load center as the at least one second size. The load determination unit can determine at least the speed or the acceleration of the load center as the at least one first size with the sensor values after adjusting the patient bearing surface. The error recognition unit can compare the speed or acceleration of the load center predicted by the calculation unit with the speed or acceleration of the load center determined by the load determination unit and detect an error and/or a possible error if the deviation exceeds the predetermined value.

According to a fourth aspect of the present disclosure, the load determination unit can determine the load and/or the center of the load with the sensor values. The load determined by the load determination unit and/or the center of the load are the first sizes. The calculation unit can calculate theoretical sensor values which serve as the second sizes. The theoretical sensor values can be calculated from one or more of the following parameters, for example: the load, the coordinates of the load center, the sensor values and/or one or more distances of the load sensors to one another. The theoretical sensor values are those sensor values the load sensors should issue at the load determined by the load determination unit and/or the determined load center. The error recognition unit can compare the sensor values issued by the load sensors with the theoretical sensor values calculated by the calculation unit. If the deviation between the sensor values issued by the load sensors and the theoretical sensor values calculated by the calculation unit exceeds the predetermined value, the error recognition unit can detect an error and/or a possible error. The error can in particular be an error of at least one of the load sensors.

The error recognition unit is advantageously able to detect an error and/or a possible error even if the patient bearing surface is not adjusted, i.e. if the patient bearing surface is in a static condition.

In order to be able to determine the load and the load center, a certain number of load sensors is required. If only one direction, the x-direction, for example, the load and the load center are determined, only two load sensors are required. If the measurement is made in two directions, the x- and the y-direction, three load sensors are required for the static determination. In one design, the load sensor arrangement can have at least one more load sensor than is required for the static determination. If two load sensors are sufficient for the static determination, the load sensor arrangement can have at least three load sensors. If three load sensors are required for the static determination, the load sensor arrangement can have at least four load sensors.

The at least one additional load sensor enables some redundancy. Viewed mathematically, there are endless combinations of the three or four forces measured by the load sensors which lead to the exact same load and the same load center. But according to the rules of the solution of statically balanced systems, there is only one correct combination of the three or four measured forces which leads to a particular load and a particular load center. If one of the load sensors is damaged, it is statistically impossible that this load sensor randomly adopts the correct value which creates a balanced system. Therefore, the system balance ban be characterized by the comparison of the measures values of the three or four load sensors with the theoretical values which the load sensors are to measure for the determined load center and the load. If the imbalance is over a particular threshold value, at least one of the load sensors does not work properly.

In some designs, the several load sensors can be arranged in a single common plane. In some designs, the load sensors can be arranged symmetrically.

In one design, the load sensors of the load sensor arrangement can be arranged parallel and mirror-inverted to one another. For example, the load sensor arrangement can have four load sensors or weighing cells in total. This design has the advantage of increased accuracy and reliability.

Several or all of the load sensors of the load sensor arrangement can be arranged mirror-symmetrically with regard to a first imaginary axis and mirror-symmetrically with regard to a second imaginary axis. The first and the second axis can be aligned orthogonally to one another. For example, the first axis can run parallel to a main axis of the patient bearing surface, while the second axis runs perpendicular to this main axis, but parallel to the patient bearing surface. The load sensor arrangement can be arranged between the patient bearing surface and the operating table column.

In some designs, the load sensors are arranged in a grating pattern or grid with a plurality of load sensors on each “side”. In some embodiments, all load sensors are arranged in a common plane. For example, the load sensors can be arranged in a 2×2 grid. The load sensors can be arranged in a grid arrangement with 2 to 4 load sensors in each dimension, for example.

The load sensors which are arranged mirror-symmetrically can be aligned in the same direction. In particular, the load sensors which are arranged mirror-symmetrically can be aligned parallel to one another. The load sensors can each have a main axis, wherein the main axes are arranged parallel to one another.

The load sensors of the load sensor arrangement can be structurally identical.

In some embodiments, the load sensors have an elongated shape. For example, the load sensors can be rectangular bodies.

According to a fifth aspect of the present disclosure, the error recognition unit can detect a possible error of at least one of the load sensors if the load determined by the load determination unit is negative.

When all load sensors work correctly, the measured load and thus the measured weight should be positive. However, if the measured load is negative, the operating table either collides with an obstacle or the load sensors do not work correctly. A negative force threshold value can be used to determine if the load sensors work correctly.

According to a sixth aspect of the present disclosure, the error recognition unit can detect an error and/or a possible error of at least one of the load sensors if the load determined by the load determination unit exceeds a predetermined value and/or the load center determined by the load determination unit lies outside a predetermined space.

The operating table is provided for operation under particular conditions. Therefore, uncommon load values, i.e. a load value of 1000 kg, indicate that the load sensors do not work correctly. The same applies to the determined load center. If the x-, y- or z-component of the center is unusually high, e.g. an x-coordinate of the center has a value of 5.32 m, this is an indication that the load sensors do not work reliably. In the error recognition unit, threshold values can be set in order to control whether the measured load and the load center are plausible.

According to a seventh aspect of the present disclosure, the error recognition unit can detect an error and/or a possible error of one of the load sensors if the load sensor does not change its sensor value while the other load sensors change their sensor values or if the load sensor changes its sensor value while the other load sensors do not change their sensor values.

Generally, the load sensors recognize even the smallest change of the load. In most cases in which a load or center change occurs, e.g. caused by a longitudinal movement of the patient, all load sensors change their values. If one of the load sensors does not change its value, this indicates that the load sensor is defective.

This also applies to the reversed case. If only one of the load sensors changes its value and the values of all other load sensors remain unchanged, this is an indication that the one load sensor which changes its value is defective.

According to an eighth aspect of the present disclosure, the error recognition unit can detect an error and/or a possible error of one of the load sensors if the load determined by the load determination unit F_{measured} does not follow the following equation (1) in case of a trend and/or tilt of the patient bearing surface:

$${F}_{m e a s u r e d} = {F}_{l o a d} \cdot cos α - ( 1 - cos α ) \cdot {F}_{d l} , \qquad ( 1 )$$

wherein F_{load} is a load acting on the patient bearing surface, α is the trend and/or tilt angle of the patient bearing surface and F_{dl} is a tared load which comprises all loads which are part of the operating table and are above the load sensors. The trend and/or tilt angle α is the angle which is formed by the vectors of weight force F_{load} and the measured force F_{measured}. The force F_{measured} runs perpendicularly to the main surface of the patient bearing surface. Equation (1) is valid only if the force sensors are trended or tilted together with the patient bearing surface. If the load sensors are attached on the foot of the operating table, for example, equation (1) does not apply.

If the patient bearing surface is tipped in any direction, the measured weight seems lower for the load sensors as the gravity sensor does not act perpendicularly to the load sensors anymore. Consequently, the error recognition unit can determine a malfunction of the load sensors if the patient bearing surface is tipped in any direction and the load F_{measured} determined by the load determination unit does not correspond to equation (1).

As already described above, the adjustment of the patient bearing surface can comprise one or more of the following operations: trending the patient bearing surface, tilting the patient bearing surface, longitudinally displacing the patient bearing surface, laterally displacing the patient bearing surface and laterally displacing the patient bearing surface.

The error recognition unit can not only detect an error of the load sensors, but also errors and/or possible errors of other sensors which are employed in the operating table. In some embodiments, the error recognition unit can detect a sensor error of one or more of the following sensors: load sensors, sensors for detecting the trend of the patient bearing surface, sensors for detecting the tilt of the patient bearing surface, sensors for detecting the longitudinal displacement of the patient bearing surface, sensors for detecting the lateral displacement of the patient bearing surface and column lift sensors.

The error recognition unit cannot detect errors of the column lift sensors, which measure a lateral displacement of the patient bearing surface, in all systems. In some systems, the column lift sensors can be used to determine the trend and/or tilt angles. It could be concluded from a faulty trend and/or tilt angle that at least one of the column lift sensors is possibly faulty.

If the error recognition unit detects an error, the error recognition unit can create an error signal which indicates that the operating table is in a safety-critical condition.

Further, an acoustic and/or optical warning signal can be generated. Moreover, a warning signal in text form can be created, which can be displayed for the user on a remote control of the operating table, for example. Furthermore, the movement of the operating table can be restricted. For example, deployment and/or trend and/or tilt of the patient bearing surface and/or the method of the operating table can be slowed down or stopped. Moreover, at least one functionality of the operating table can be blocked.

The measures taken can be reduced or cancelled if the error recognition unit determines a safe condition of the operating table again.

According to a ninth aspect of the present disclosure, a method for detecting an error of a sensor in an operating table and/or an error when determining a load or a load center is provided. The operating table comprises an adjustable patient bearing surface for bearing a patient and a load sensor arrangement with several load sensors which issue sensor values. With the sensor values, at least one of the following first sizes can be determined: a load, a center of the load, a speed of the load center and an acceleration of the load center. The load can be a load acting on the load sensor arrangement or a load acting on the operating table or a total load of the operating table. With the at least one first size, at least one expected second size can be calculated. The sensor values or at least one first size can be compared with the at least one expected second size. If the deviation of the sensor values or the at least one first size from the at least one expected second size exceeds a predetermined value, an error can be detected.

The method according to the ninth aspect can have all designs which are described in the present disclosure in connection with the system according to the first to eighth aspect.

The present disclosure also comprises circuits and/or electronic instructions for controlling operating tables and remote controls, displays and user interfaces for use with operating tables.

### SHORT DESCRIPTION OF THE DRAWINGS

Example embodiments of the present disclosure are explained in more detail hereinafter with the figures: In the drawings:

FIG. 1 shows a schematic lateral view of an operating table with a patient positioned on a patient bearing surface of the operating table;

FIG. 2 shows a schematic representation of the system architecture of an operating table system according to the disclosure with a load sensor arrangement, a load determination unit, a calculation unit and an error recognition unit;

FIG. 3 shows a schematic representation of an operating table according to the disclosure for illustrating the measuring load, the active load and the total load;

FIGS. 4A to 4C show schematic representations of different embodiments of an operating table according to the disclosure with a load sensor arrangement in different positions;

FIGS. 5A to 5D show schematic representations of different embodiments of an operating table according to the disclosure with force sensors arranged in parallel and mirror-symmetrically;

FIGS. 6A and 6B show schematic representations for illustrating the forces acting on the force sensors;

FIGS. 7A and 7B show schematic representations for illustrating the reduction of transverse forces due to the symmetrical arrangement of the force sensors;

FIG. 8 shows a schematic representation for illustrating the determination of the gravitational vector with a trended patient bearing surface:

FIG. 9 shows a schematic representation of an operating table system according to the disclosure with an iterative operating method for detecting an error;

FIGS. 10A and 10B show schematic representations of an operating table according to the disclosure for illustrating the movement of the load center with a trend of the patient bearing surface;

FIG. 11 shows a schematic representation of an iterative method for detecting an error with the help of a Kalman filter;

FIG. 12 shows a schematic representation of the system model of the Kalman filter;

FIG. 13 shows schematic representations of a tilt rotation and a trend rotation;

FIG. 14 shows a schematic representation of an operating table system according to the disclosure with a method for detecting an error by means of the system imbalance;

FIG. 15 shows a schematic representation of the functioning of the operating table system of FIG. 14; and

FIGS. 16a and 16b show schematic representations of different simulated system imbalances.

### DETAILED DESCRIPTION OF THE FIGURES

In the following description, example embodiments of the present disclosure are described with reference to the drawings. The drawings are not necessarily drawn to scale, but are intended to only schematically illustrate the respective features.

It is to be noted that the features and components described below can each be combined with one another, irrespective of whether they were described in connection with a single embodiment. The combination of features in the respective embodiments only serves to illustrate the general setup and the functioning of the claimed device.

In the figures, identical or similar elements are indicated with identical reference numerals as far as this is appropriate.

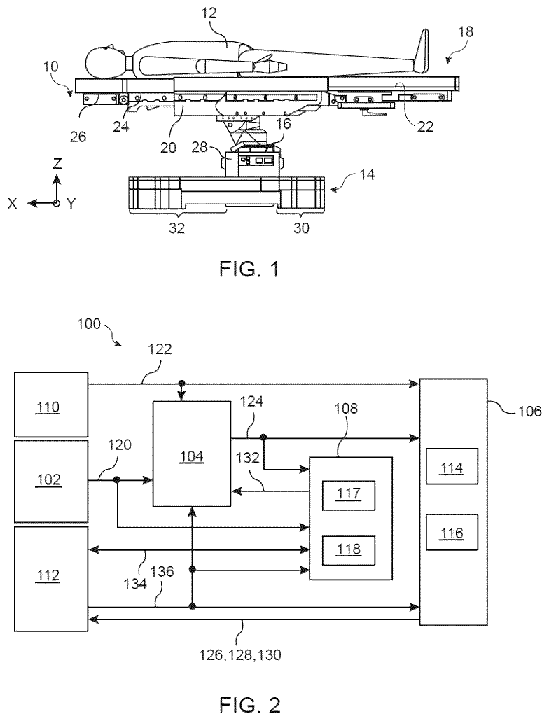

FIG. 1 schematically shows a mobile operating table 10 which can be used for bearing a patient 12 during a surgical intervention and for transporting them. The mobile operating table 10 comprises, from bottom to top, a foot 14 for placing the operating table on an underground, an operating table column 16 comprising the foot 14 and being perpendicularly arranged, and a patient bearing surface 18 fastened at an upper end of the operating table column 16. The patient bearing surface 18 can be firmly connected to the operating table column 16 or alternatively be detachably fastened on the operating table column 16.

The patient bearing surface 18 is formed modularly and serves to bear the patient 12. The patient bearing surface 18 comprises a bearing surface main section 20 connected to the operating table column 16 which can be extended as desired by coupling diverse bearing surface subsections. In FIG. 1, a leg section 22, a shoulder section 24 and a head section 26 are coupled to the bearing surface main section 10 as bearing surface subsections.

Depending of the type of surgical intervention to be performed, the patient bearing surface 18 of the operating table 10 can be brought to a suitable height and both trended and tilted.

The operating table column 16 is formed to be adjustable in height and has an internal mechanics for adjusting the height of the patient bearing surface 18 of the operating table 10. The mechanics is arranged in a housing 28 which protects the components from pollution.

The foot 14 has two sections 30, 32 of different lengths. Section 30 is a short section which is assigned to a foot end of the leg section 22, i.e. the end of the patient bearing surface 18 on which the feet of the patient 12 to be treated lie. Section 32 is a long section which is assigned to the head section 26 of the patient bearing surface 18.

Furthermore, the foot 14 can have wheels or rolls with which the operating table 10 can be moved on the ground. Alternatively, the foot 14 can be fixedly anchored on the ground.

For better illustration, a Cartesian coordinate system X-Y-Z is inserted in FIG. 1. The X-axis and the Y-axis are the horizontal axes, the Z-axis is the perpendicular axis. The X-axis extends along the bearing surface subsections 22, 24, 26 arranged next to one another.

FIG. 2 schematically shows the system architecture of an operating table system 100 according to the disclosure. The operating table system 100 is a system according to the first aspect of the present disclosure and can be operated with a method according to the ninth aspect.

Apart from an operating table 10 as represented in FIG. 1, the operating table system 100 has a load sensor arrangement 102, a load determination unit 104, a safety unit 106, a monitoring and calibration unit 108, a data storage 110 as well as further components 112 of the operating table system 100. Further, the safety unit 106 contains a tipping prevention unit 114 and an overload protection unit 116. The monitoring and calibration unit 108 comprises a calculation unit 117 and an error recognition unit 118.

The load sensor arrangement 102 contains several load sensors and is formed to measure at least one size from which a load acting on the load sensor arrangement 102 can be determined. In the present case, the load sensors are force sensors which respectively measure a force acting on the respective sensor. The sensor or force values measured by the individual force sensors are issued by the load sensor arrangement 102 as a signal 120 in a digital form. Further, the load sensor arrangement 102 contains electronic components which are required for operation of the force sensors.

The load determination unit 104 receives the signal 120 with the measured sensor or force values and determines at least one first size therefrom, wherein the first sizes can be the following sizes: a load, a center of the load, a speed of the load center and/or an acceleration of the load center. The load determination unit 104 can determine a measuring load, an active load and/or a total load as the load.

In order to be able to adequately process and analyze the delivered force values, the load determination unit 104 requires some data relating to geometry and the masses or weights of the operating table 10 and the accessory parts. These date are stored in the data storage 110 and are provided to the load determination unit 104 by means of a signal 122. From these data, in particular, information on the masses and centers of the individual components of the operating table 10 and the accessory parts can be taken. The data storage 110 can be extended via a connectivity module of the operating table 10.

The load determination unit 104 creates a signal 124 as an output signal which contains information on the at least one first size, i.e. the determined loads and/or load centers and, if applicable, speeds and/or accelerations of the load centers. Further, the signal 124 contains the sensor values issued by the load sensors. These information are transmitted both to the safety unit 106 and to the monitoring and calibration unit 108.

In the safety unit 106, all available data are analyzed, including the loads, centers and the position data of the operating table 10 and the accessory parts recognized by the operating table 10. The safety unit 106 decides whether the operating table 10 is safe or whether it is in a dangerous situation. The safety unit 106 creates a safety signal 126 which indicates whether the operating table 10 is in a safety-critical condition.

Depending on the severity of the detected situation, the algorithm reacts correspondingly. The operating table 10 can only issue a warning, for example, or stop the movement. The warnings can be via an acoustic or optical signal through the operating table or in the form of text via the remote control. The measures can vary from slowing down the movement speed to stopping the movement or blocking some functions and last until a condition is reached in which the operating table 10 is safe again.

It can be provided that the safety features can be deactivated by the user at all times and the movement of the operating table 10 is continued at their own risk.

The tipping prevention unit 114 and the overload protection unit 116 are subunits of the safety unit 106. With the total load and/or the center of the total load, the tipping prevention unit 114 creates a tipping safety signal 128 which indicates whether there is a risk of the operating table 10 tipping. With the active load and/or the center of the active load, the overload protection unit 116 creates an overload protection signal 130 which indicates whether there is an overload risk for the operating table 10 and/or at least one component of the operating table 10. Alternatively, the overload protection unit 116 can use the measuring load or the total load and/or the center of one of these loads for creating the overload protection signal 130. Both the tipping safety signal 128 and the overload protection signal 130 are safety signals of the safety unit 106.

If the foot 14 does not have any wheels or rolls and instead is firmly connected to the ground, the tipping prevention unit 114 can be deactivated or not be implemented in the safety unit 106.

As the system 100 is to recognize critical situations reliably, the system 100 also has a monitoring and calibration unit 108. This software module checks the plausibility of the measuring values and recognizes whether the system works incorrectly or whether a calibration or taring or the system 100 is required. The monitoring and calibration unit 108 creates corresponding output signals 132, 134, which are transmitted to the load determination unit 104 or the components 112 of the operating table 10.

The calculation unit 117 integrated in the monitoring and calibration unit 108 obtains the signal 124 from the load determination unit 104 which contains information on the at least one first size, i.e. the determined loads and/or load centers and, if applicable, speeds and/or accelerations of the load centers. The calculation unit 117 calculates at least one expected second size with the at least one first size.

The error recognition unit 118 makes a comparison between the values determined by the load sensor arrangement 102 or the load determination unit 104 and the expected second size determined by the calculation unit 117 in that the error recognition unit 118 compares the sensor values issued by the load sensors or the at least one first size with the at least one expected second size. If the deviation of the at least one expected second size from the sensor values or the at least one first size exceeds a predetermined value, the error recognition unit 117 determines that there is an error. The error can be a faulty sensor, for example, or an error which occurs when the load or the load center is determined. The error recognition unit 118 creates an error signal 138 which is transmitted to the safety unit 106. The detected errors and the error signal 138 can be interpreted as possible errors or contain a possible error. In some designs, it can be provided that further examinations are required until it is determined that there really is an error.

If the error recognition unit 118 detected an error and/or a possible error, the safety unit 106 is informed by means of the error signal 138. The safety unit 106 can then take the required measures. As described above, a warning can be issued, for example, or the movement of the operating table 10 can be slowed down or stopped.

The components 112 of the operating table 10 continuously generate position data, data for adjusting individual components and information on the accessories recognized by the operating table 10. These data are provided to the system 100 with a signal 136.

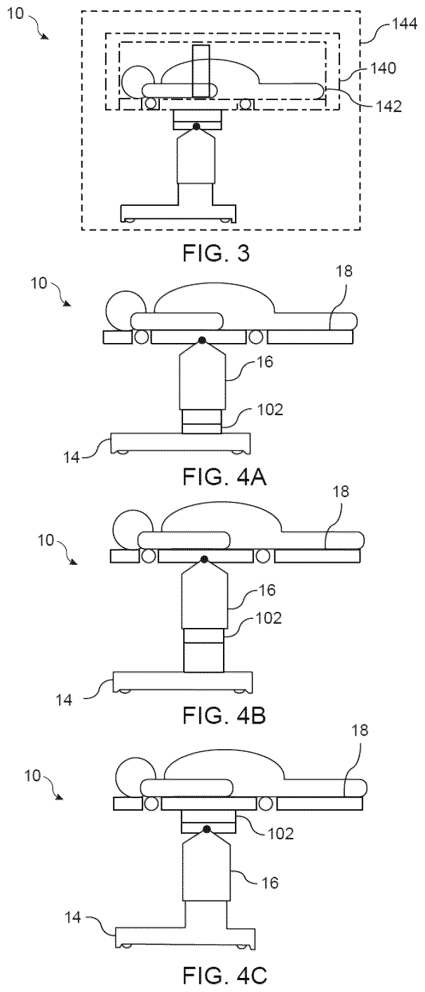

FIG. 3 schematically illustrates the different loads the load determination unit 104 can determine with the data delivered by the load sensor unit 102. In FIG. 3, the measuring load, the active load and the total load are characterized by reference numerals 140, 142 and 144. The load determination unit 104 can determine the position of the related load center as well as the speed and/or the acceleration of the load center for each one of these loads.

The measuring load is the load which acts on the load sensor arrangement 102. The measuring load corresponds to the load which is created by all persons, objects and forces on the operating table 10 above the load sensors. The measuring load corresponds to the load value which is measured by the load sensor arrangement 102.

The active load corresponds to the load which is caused by components which are not assigned to the operating table 10 and persons and external forces and acts on the operating table 10. The active load does not take into account the influence of the components assigned to the operating table 10 and of recognized accessory parts. Only the other components of the operating table 10 contribute to the active load, i.e. the components which are not assigned to the operating table 10. These can be accessory parts, for example, which are not recognized by the operating table 10. Furthermore, the patient located on the operating table 10 contributes to the active load. Moreover, all forces acting externally on the operating table 10, which are applied to the operating table 10 by persons and/or objects outside the operating table 10 for example, contribute to the active load. Generally, the active load is the measuring load without the influence of the known objects such as table plate parts, recognized accessories etc.

The total load is the load which results from the measuring load and from a load caused by components which are assigned to the operating table 10 and are below the load sensor arrangement 102. Consequently, the total load considers loads from components which are located below the load sensor arrangement 102 and cannot be measured by the load sensor arrangement 102 and thus do not contribute to the measuring load. Consequently, the total load is the load which results from the complete operating table 10, the patient, the components assigned to the operating table 10, the components not assigned to the operating table 10 and other external forces.

FIGS. 4A to 4C schematically show the operating table 10 according to the disclosure in different embodiments.

In the operating table 10, the load sensor arrangement 102 with the several load sensors is arranged between at least two parts of the operating table 10. In particular, the at least two parts substantially cannot be movable to one another. In this design, the at least two parts substantially do no move to one another, i.e. they substantially remain in the same position to one another, if, during operation of the operating table 10, in particular the patient bearing surface 18 is adjusted, e.g. when trending and/or tilting and/or deploying the patient bearing surface 18. This applies both to the distance of the at least two parts to one another and the one or more angles the at least two parts include(s) together.

The load sensor arrangement 102 is preferably integrated in the operating table 10 so that the full load above the load sensors flows through the load sensor arrangement 102 or is transmitted by it.

The load sensor arrangement 102 can be arranged at different positions in the operating table 10. In the embodiment represented in FIG. 4A, the load sensor arrangement 102 is arranged between the foot 14 and the operating table column 16, while the load sensor arrangement 102 in FIG. 4B is integrated in the operating table column 16. In FIG. 4C, the load sensor arrangement 102 is adjacent to the interface between the patient bearing surface 18 and the operating table column 16.

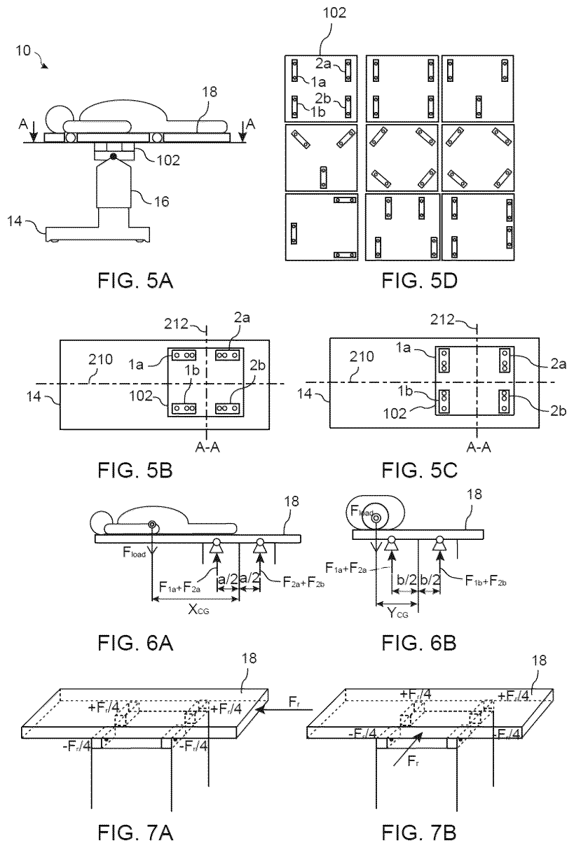

FIG. 5A shows the operating table 10 with a load sensor arrangement 102 arranged between the patient bearing surface 18 and the operating table column 16. The load sensor arrangement 102 contains four structurally identical load sensors 1a, 1b, 2a and 2b which are arranged in parallel and mirror-inverted to one another. Two different variants for placing the force sensors 1a, 1b, 2a, 2b are illustrated in FIGS. 5B and 5C.

FIGS. 5B and 5C each show a top view of the load sensor arrangement 102 along a line A-A which is drawn in FIG. 5A. In some designs, the load sensor arrangement 102 can contain at least three or at least four force sensors.

For alignment of the force sensors 1a, 1b, 2a, 2c, a first axis 210 and a second axis 212 are provided which are perpendicular to one another. The first axis 210 extends parallel to a main axis of the patient bearing surface 18, while the second axis 212 runs perpendicular to this main axis, but parallel to the patient bearing surface 18.

The force sensors 1a, 1b, 2a, 2c each have a main axis which is aligned parallel to the first axis 210 in FIG. 5B. In FIG. 5C, the main axes of the load sensors 1a, 1b, 2a, 2b are arranged parallel to the second axis 212. Further, the force sensors 1a, 1b, 2a, 2b are each arranged in pairs and mirror-symmetrically to the axes 210, 212. The pairs (1a, 1b), (1a, 2a), (1b, 2b) and (2a, 2b) each form a mirror-symmetrical force sensor pair. In some embodiments, the force sensors 1a, 1b, 2a, 2b are arranged in a 2×2 grid as represented. In some embodiments, the grid arrangement has at least two force sensors 1a, 1b, 2a, 2b on each side. In some embodiments, the force sensors 1a, 1b, 2a, 2b all lie in a single common plane which is intersected both by the first axis 210 and by the second axis 212.

The force sensors can also be arranged within the sensor arrangement 102 differently than in FIGS. 5B and 5C. Several example alternative arrangements of the force sensors in the sensor arrangement 102 are represented in FIG. 5D.

With the example of the sensor arrangement 102 represented in FIG. 5B or 5C, the measured load can be calculated by adding all of the forces measured by the sensors 1a, 1b, 2a, 2b. The corresponding center can be calculated with the help of the torque compensation equation indicated below and the forces represented in FIGS. 6A and 6B. FIG. 6A shows a sectional representation along the x-axis and FIG. 6B shows a sectional representation along the y-axis. The torque compensation equation can be applied in both directions so that the x- and y-component of the center can be determined:

$${F}_{l o a d} = {F}_{1 a} + {F}_{2 a} + {F}_{1 b} + {F}_{2 b} \qquad ( 2 )$$

$${X}_{C G} = \frac{{F}_{1 a} + {F}_{1 b}}{{F}_{l o a d}} a - \frac{a}{2} \qquad ( 3 )$$

$${Y}_{C G} = \frac{{F}_{1 a} + {F}_{2 a}}{{F}_{l o a d}} b - \frac{b}{2} \qquad ( 4 )$$

In equations (2) to (4), F_{Last} is the weight force created by the patient. The forces F₁ₐ, F_{1b}, F₂ₐ and F_{2b} are the forces measured by the sensors 1a, 1b, 2a, 2b. The parameters a and b are the distances of the sensors in the x- and in the y-direction. X_{CG} and Y_{CG} are the x- and y-coordinates of the center of the load caused by the patient.

The active load and the total load as well as their corresponding center values can be calculated by adding or subtracting the corresponding components of the operating table 10 and their center values which are stored in the data storage 110.

The arrangements of the sensors 1a, 1b, 2a, 2b proposed in FIGS. 5B and 5C makes the system robust against transverse forces Fr. Due to the symmetric arrangement, transverse forces Fr are cancelled, as shown in FIGS. 7A and 7B.

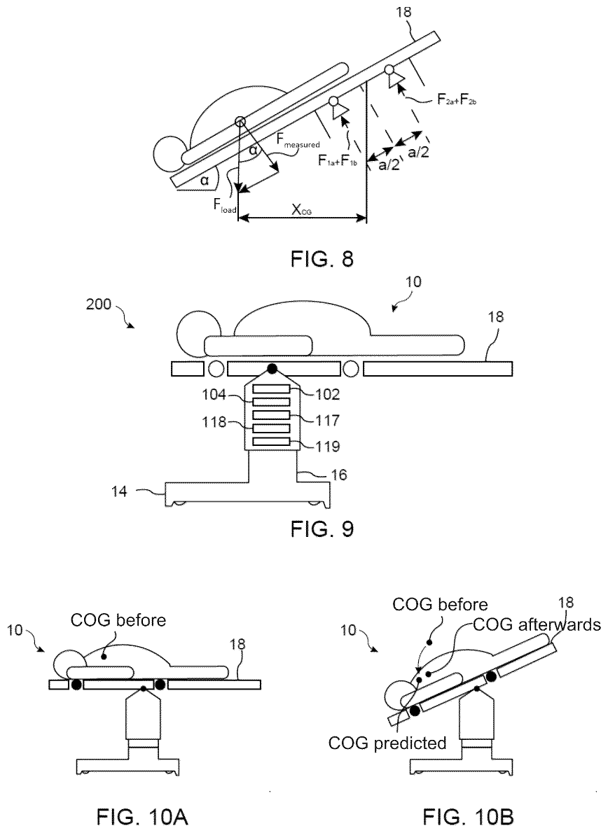

The cancellation of the transverse forces also enables the described system to reliably measure forces and centers if the patient bearing surface 18 is in a trended position. FIG. 8 shows how the gravitation vector F_{Last} can be divided into two components. One component is laterally to the force sensors and is cancelled due to the effects explained above. The second component F_{measured} runs perpendicular to the force sensors or the main surface of the patient bearing surface 18 and is measured reliably. When knowing the trend angle α of the patient bearing surface 18, the actual force above the sensors and its center can be calculated.

FIG. 9 schematically shows an operating table system 200 according to the disclosure which in large parts is similar to the operating table system 100 schematically represented in FIG. 2. Elements of the operating table system 200 which are identical or similar to elements of the operating table system 100 are indicated with identical reference numerals.

The operating table system 200 is a system according to the second aspect of the present disclosure. Apart from the operating table 10, the operating table system 200 comprises a load sensor arrangement 102 with several load sensors, a load determination unit 104, a calculation unit 117, an error recognition unit 118 and a condition estimation unit 119. The condition estimation unit 119 can be integrated in the monitoring and calibration unit 108 together with the calculation unit 117 and the error recognition unit 118.

Before the individual components and the functioning of the operating table system 200 are described, the physical and mathematical considerations the operating table system 200 is based on should be explained first.

If the patient or the working load of the operating table 10 is moved during a trend or tilt of the patient bearing surface 18, the center of the working load moves along a circular trajectory which can be calculated in advance. If the patient bearing surface is moved in the longitudinal direction, the working load moves along a linear trajectory. Therefore, it is possible to make an estimation over the complete trajectory of the working load when the patient bearing surface is adjusted or moved.

This consideration helps to utilize the position sensors of the operating table 10 in order to check the load center determined by the load sensors (and vice versa). If a sensor has an error, the trajectory determined for the working load does not act as expected. The expected trajectory can be calculated with the help of the kinematics of the operating table 10 and physical relationships which are known from classical mechanics.

This principle is to be illustrated with FIGS. 10A and 10B. FIG. 10A shows the operating table 10 with the patient bearing surface 18 in a horizontal position. The center of the patient is marked in FIG. 10A and characterized by reference numeral COG_{before}. The patient bearing surface 18 is now trended, whereby the center of the patient moves along a circular trajectory. The center of the patient after adjustment of the patient bearing surface 18 is characterized by COG_{afterwards} in FIG. 10B. The center COG_{afterwards} can be determined with the help of the sensor values of the load sensors. Further, the center of the patient which is reached due to a trend of the patient bearing surface 18 can be predicted or forecast or pre-calculated or estimated. The predicted center is referred to as COG_{predicted} in FIG. 10B. If the deviation of the center COG_{afterwards} from the predicted center COG_{predicted} is too large, it can be concluded that there is an error.

The detected error can be caused by a defective sensor. The defective sensor can be a load sensor, a sensor for detecting the trend of the patient bearing surface, a sensor for detecting the tilt of the patient bearing surface, a sensor for detecting the longitudinal displacement of the patient bearing surface or a sensor for detecting the lateral displacement of the patient bearing surface, for example. However, the error can also have occurred during determination of the load or the load center.

In the following, the mathematical steps are explained which the operating table system 200 uses for detecting an error.

The load center, i.e. a point with x-, y- and z-coordinates in the unit in meters, as well as the position of the joints for the trend and tilt of the patient bearing surface 18 in the unit in degrees and the longitudinal displacement of the patient bearing surface 18 in the unit in meters are used as input values.

The speed \vec{v}_{cg,linear} of the load center, which is caused by a longitudinal and/or lateral displacement of the patient bearing surface 18, can be determined by deriving the longitudinal displacement \vec{x}_{longitudinal_displacement} and the lateral displacement \vec{x}_{lateral_displacement} after the time:

$${\vec{v}}_{cg , linear} = \frac{d {\vec{x}}_{longitudinal \_ displacement}}{d t} + \frac{d {\vec{x}}_{lateral \_ displacement}}{d t} = {\vec{v}}_{longitudinal \_ displacement} + {\vec{v}}_{lateral \_ displacement} \qquad ( 5 )$$

The speed \vec{v}_{cg,circulation} of the load center, which is caused by a trend and/or tilt of the patient bearing surface 18, can be determined with the circulation speed.

$${\vec{v}}_{cg , circulation} = ( \frac{d {\vec{φ}}_{t i l t}}{d t} + \frac{d {\vec{φ}}_{t r e n d}}{d t} ) \times \vec{r} = ( {\vec{ω}}_{t i l t} + {\vec{ω}}_{t r e n d} ) \times \vec{r} , \qquad ( 6 )$$

wherein \vec{ω}ₜᵢₗₜ and \vec{ω}_{trend} are the revolution speeds of the load center during the trend or tilt of the patient bearing surface 18. \vec{r} is the distance between the measured load center and the rotational axis of the trend/tilt joints.

The total speed \vec{v}_{cg} of the load center is composed of the speeds \vec{v}_{cg,linear} and \vec{v}_{cg,circulation} and can be determined with the following sum:

$${\vec{v}}_{cg} = {\vec{v}}_{cg , circulation} + {\vec{v}}_{cg , linear} = {\vec{ω}}_{tilt / trrend} \times \vec{r} + {\vec{v}}_{longitudinal \_ displacement} + {\vec{v}}_{lateral \_ displacement} \qquad ( 7 )$$

The equations above enable to iteratively predict the estimated load center. If the speed of the center X_{CG} is known, the estimated position X_{CG+} of the center can be determined after a short time T.

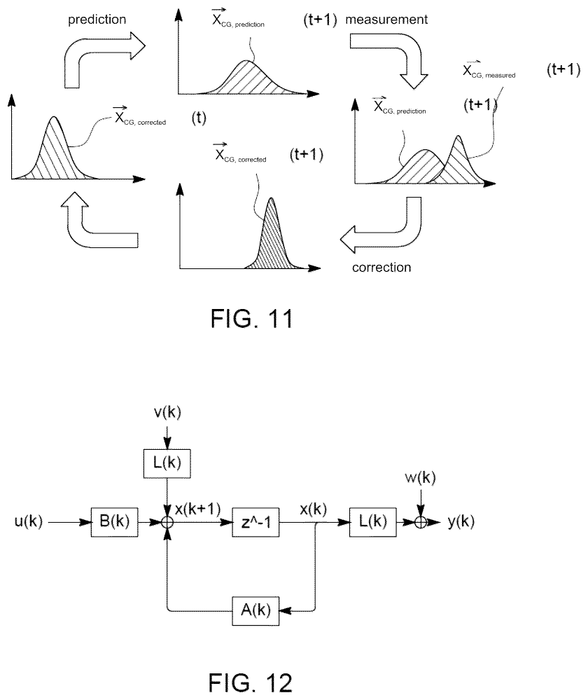

In order to be able to detect an error, the operating table system 200 applies an iterative method which is illustrated in FIG. 11. In doing so, a current actual load center \vec{x}_{CG,corrected}(t) at the time t is assumed. As is explained further below, the load center \vec{x}_{CG,corrected}(t) is the actual load center estimated by the condition estimation unit 119 in the preceding iteration cycle. The calculation unit 117 predicts the load center \vec{x}_{CG,prediction}(t+1) at the time t+1 with the actual load center \vec{x}_{CG,corrected}(t) at the time t. At the time t+1, sensor values of the load sensors are received and the load determination unit 104 determines the load center \vec{x}_{CG,measured}(t+1) at the time t+1 with the sensor values. The condition estimation unit 119 then performs a correcting step for which it uses a Kalman filter. The condition estimation unit 119 estimates the actual load center \vec{x}_{CG,corrected}(t+1) at the time t+1 with the load center \vec{x}_{CG,prediction}(t+1) at the time t+1 predicted by the calculation unit 117 and the load center \vec{x}_{CG,measured}(t+1) at the time t+1 determined by the load determination unit 104. Consequently, the values \vec{x}_{CG,prediction}(t+1) and \vec{x}_{CG,measured}(t+1) serve as inputs for the Kalman filter. The use of both information sources—prediction and measurement—leads to a more reliable condition estimation.

Subsequently, another iteration cycle is performed, where the actual load center \vec{x}_{CG,corrected}(t+1) at the time t+1 is assumed. The calculation unit 117 predicts the load center \vec{x}_{CG,prediction}(t+2) at the time t+2 with the actual load center \vec{x}_{CG,corrected}(t+1) at the time t+1. Moreover, the load determination unit 104 determines the load center \vec{x}_{CG,measured}(t+2) at the time t+2 with the sensor values of the load sensors recorded at the time t+2. With the help of the Kalman filter, the condition estimation unit 119 estimates the actual load center \vec{x}_{CG,corrected}(t+2) at the time t+2 with the load center \vec{x}_{CG,prediction}(t+2) at the time t+2 predicted by the calculation unit 117 and the load center \vec{x}_{CG,measured}(t+2) at the time t+2 determined by the load determination unit 104. The method is continued correspondingly.

In the supervision algorithm described above, the Kalman filter is used in order to iteratively determine the position estimation of the load center in a similar way. If a measurement of the current position deviates too much from the prediction over a particular time period, there can be an error in the sensors or when determining the load or the load center as the load center does not behave plausibly.

The error recognition unit 118 can compare the load center \hat{x}_{CG,prediction}(t) predicted by the calculation unit 117 with the load center \vec{x}_{CG,measured}(t) determined by the load determination unit 104 in every iteration cycle. If the deviation or the distance of the two load centers is too large and exceeds a predetermined value or distance, for example, the error recognition unit 118 can detect an error and/or a possible error.

Since the load can reversibly deform the operating table in some positions, the tolerances for the recognition of an error should be large enough in order to avoid wrong positive results. Therefore, a tolerance range should be defined which distinguishes between a real error, for example a sensor error, and sensor noise and inaccuracies of the system model.

The Kalman filter can be simplified by comparing, according to the third aspect of the present disclosure, the speed or acceleration of the load center calculated from the kinematics of the operating table 10 with the speed or acceleration of the load center derived from the center measurement instead of estimating the position of the load center. If the deviation between the speeds or accelerations is too large, there is an error.

For illustrating the functioning of the Kalman filter, an example algorithm is indicated hereinafter, which can be executed by the Kalman filter. For the sake of simplicity, it is assumed that the trend and tilt rotational axes have the same origin. The distance between the rotational axis of the trend and the tilt and the measured center (X_{CG}) is indicated as a distance (radius of the circular path). The speed v_{CG} of the center can be determined as follows:

$$v \text{?} = {\vec{ω}}_{LS} \times \vec{r} + {\vec{v}}_{LS} \qquad ( 8 )$$

$$v \text{?} = ω \text{?} \cdot r \text{?} - ω \text{?} \cdot r \text{?} + v \text{?}$$

$$v \text{?} = ω \text{?} \cdot r \text{?} - ω \text{?} \cdot r \text{?} + v \text{?}$$

$$v \text{?} = ω \text{?} \cdot r \text{?} - ω \text{?} \cdot r \text{?} + v \text{?}$$

$$\text{?} \text{indicates text missing or illegible when filed}$$

wherein:

$${r}_{x} = {X}_{x , cg} - X \text{?} \qquad ( 9 )$$

$${r}_{y} = {X}_{y , cg} - X \text{?}$$

$${r}_{z} = {X}_{z , cg} - X \text{?}$$

$$\text{?} \text{indicates text missing or illegible when filed}$$

For the Kalman filter, a linear, time-invariant system model is adopted, as is represented in FIG. 12.

The Kalman filter is described by the following equations:

### Prediction:

$${r}_{x} = {X}_{x , cg} - X \text{?} \qquad ( 10 )$$

$${r}_{y} = {X}_{y , cg} - X \text{?}$$

$${r}_{z} = {X}_{z , cg} - X \text{?}$$

$$\text{?} \text{indicates text missing or illegible when filed}$$

### Filtration:

$$\underline{x} \text{?} ( k + 1 ) − {\underline{x}}^{⋆} ( k + 1 ) + \underline{K} ( k + 1 ) ( y ( k + 1 ) − \underline{H} ( k + 1 ) {\underline{x}}^{⋆} ( k + 1 ) ) \qquad ( 11 )$$

$$\underline{P} \text{?} ( k + 1 ) = ( \underline{I} − \underline{K} ( k + 1 ) \underline{H} ( k + 1 ) ) \cdot {\underline{P}}^{⋆} ( k + 1 )$$

$$\text{?} \text{indicates text missing or illegible when filed}$$

### Gain:

$$\underline{K} ( k + 1 ) = {\underline{P}}^{⋆} ( k + 1 ) {\underline{H}}^{T} ( k + 1 ) {( \underline{H} ( k + 1 ) {\underline{P}}^{⋆} ( k + 1 ) {\underline{H}}^{T} ( k + 1 ) + \underline{R} ( k + 1 ) )}^{− 1} \qquad ( 12 )$$

B and H can be assumed as unit or identity matrix I.
xₖ^{(m)}: System condition after application of the new observation/measurement
zₖ⁽ⁿ⁾: New observation/measurement at time k
K^{(m×n)}: Kalman Gain Matrix for projecting the residues to the correction of the system condition
A^{(m×m)}: Transition matrix for forwarding the system condition at the next time
P^{(m×m)}: Covariance matrix of the errors of \vec{x}ₖ
Q^{(m×m)}: Process noise for introducing uncertainties due to modelling errors or changing limits
H^{(n×m)}: Observation matrix for projecting the system conditions to the observation/measurement
R^{(n×n)}: Covariance of the measurement noise

A 3DOF Kalman filter with a constant speed can be assumed as follows.

This specific filter is based on a linear system with a constant speed:

$$A = ( \begin{matrix}1 & 0 & 0 & T & 0 & 0 \\ 0 & 1 & 0 & 0 & T & 0 \\ 0 & 0 & 1 & 0 & 0 & T \\ 0 & 0 & 0 & 1 & 0 & 0 \\ 0 & 0 & 0 & 0 & 1 & 0 \\ 0 & 0 & 0 & 0 & 0 & 1\end{matrix} ) \qquad ( 13 )$$

The process noise matrix is based on white noise:

$$\underline{Q} = σ \cdot ( \begin{matrix}\frac{{T}^{2}}{4} & 0 & 0 & \frac{T}{2} & 0 & 0 \\ 0 & \frac{{T}^{2}}{4} & 0 & 0 & \frac{T}{2} & 0 \\ 0 & 0 & \frac{{T}^{2}}{4} & 0 & 0 & \frac{T}{2} \\ \frac{T}{2} & 0 & 0 & 1 & 0 & 0 \\ 0 & \frac{T}{2} & 0 & 0 & 1 & 0 \\ 0 & 0 & \frac{T}{2} & 0 & 0 & 1\end{matrix} ) \qquad ( 14 )$$

The starting matrix H is preconfigured as a unit matrix. Therefore, the filter also expects the complete condition vector as measurements (x, y, z, vₓ, v_{y}, v_{z}).

If not the position of the center, but the speed of the center is considered, the algorithm can be simplified, as shown below.

The following prerequisites are assumed:
Trend as the only source of rotation about the y-axis,
tilt as the only source of rotation about the x-axis, and
longitudinal displacement only contributes to the linear speed in the x-direction.

The calculation of the speed of the load center can be simplified as follows:

$${v}_{x , cg} = {v}_{ls} + {ω}_{trend} \cdot {r}_{z , trend} \qquad ( 15 )$$

$${v}_{y , cg} = - {ω}_{tilt} \cdot {r}_{z , Tilt}$$

$${v}_{z , cg} = {ω}_{tilt} \cdot {r}_{y , tilt} - {ω}_{trend} \cdot {r}_{z , trend}$$

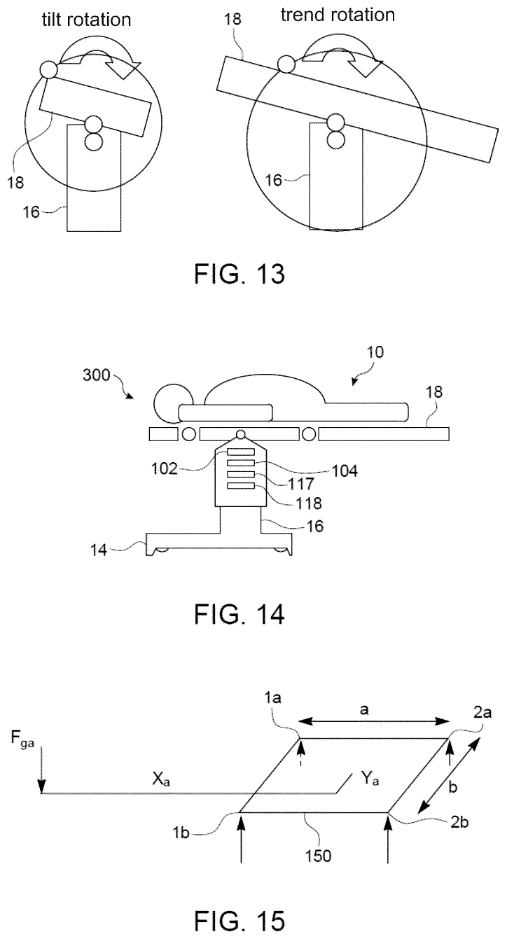

rₜᵢₗₜ and r_{trend} must be distinguished as they do not have the same rotation axis source, as is shown in FIG. 13.

FIG. 14 schematically shows an operating table system 300 according to the disclosure which in large parts is similar to the operating table system 100 schematically represented in FIG. 2. Elements of the operating table system 300 which are identical or similar to elements of the operating table system 100 are indicated with identical reference numerals.

The operating table system 300 is a system according to the fourth aspect of the present disclosure. Apart from the operating table 10, the operating table system 300 comprises a load sensor arrangement 102 with several load sensors, a load determination unit 104, a calculation unit 117 and an error recognition unit 118. The functioning of the operating table system 300 is illustrated in FIG. 15.

The load sensor arrangement 102 of the operating table system 300 has four load sensors 1a, 1b, 2a, 2b which are arranged in the corners of a virtual rectangle 150 which is represented in FIG. 15. The rectangle 150 has the lateral lengths a and b. The load sensors 1a and 2a and the load sensors 1b and 2b each have a distance a to one another. The load sensors 1a and 1b and the load sensors 2a and 2b each have a distance b to one another. The load sensors 1a, 1b, 2a, 2b measure the respective force acting on them and issue sensor values F_{1a_m}, F_{1b_m}, F_{2a_m} or F_{2b_m} which reflect the forces acting on the load sensors 1a, 1b, 2a, 2b. The load determination unit 104 determines the load F_{ga} and the load center with the coordinates Xₐ and Yₐ in the plane of the rectangle 150 with the sensor values F_{1a_m}, F_{1b_m}, F_{2a_m}, F_{2b_m}. The calculation unit 117 uses the values determined by the load determination unit 104, i.e. the load F_{ga} and the coordinates Xₐ and Yₐ of the load center, and calculates theoretical sensor values F_{1a_t}, F_{1b_t}, F_{2a_t}, F_{2b_t} with these values. The theoretical sensor values F_{1a_t}, F_{1b_t}, F_{2a_t}, F_{2b_t} are those sensor values which the load sensors 1a, 1b, 2a, 2b should issue at the load F_{ga} determined by the load determination unit 104 and the load center with the coordinates Xₐ and Yₐ. The error recognition unit 118 compares the sensor values F_{1a_m}, F_{1b_m}, F_{2a_m}, F_{2b_m} issued by the load sensors 1a, 1b, 2a, 2b with the theoretical sensor values F_{1a_t}, F_{1b_t}, F_{2a_t}, F_{2b_t} calculated by the calculation unit 117. For example, the error recognition unit 118 can calculate the difference F_{i_t}−F_{i_m} (with i=1a, 1b, 2a, 2b) for each one of the load sensors 1a, 1b, 2a, 2b. The difference F_{i_t}−F_{i_m} indicates the system imbalance. If, for example, one or more of the differences F_{i_t}−F_{i_m} exceed a predetermined value, the error recognition unit 118 detects an error and/or a possible error. In some designs, the amount of the difference F_{i_t}−F_{i_m} for all load sensors 1a, 1b, 2a, 2b can be equal. In particular, it is sufficient to check the difference F_{i_t}−F_{i_m} for only one of the load sensors 1a, 1b, 2a, 2b, as a possible error can already be recognized therefrom.

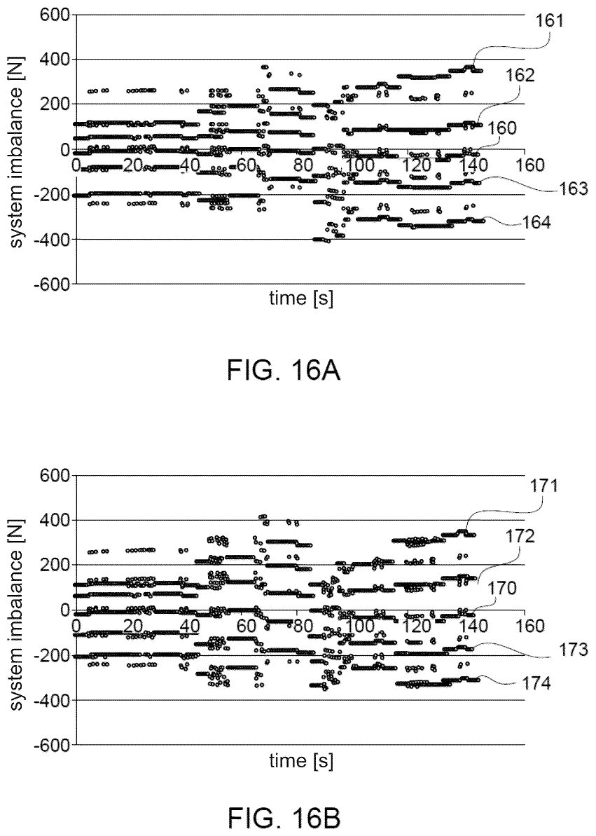

As an example, the simulated system imbalance F_{1a_t}−F_{1a_m} in FIGS. 16a and 16b for the sensor 1a is plotted against time. The patient bearing surface 18 is in a flat position. The curve 160 in FIG. 16a and the curve 170 in FIG. 16b indicate the system imbalance of the sensor 1a if the operating table system 300 works properly. All other curves show the system imbalance F_{1a_t}−F_{1a_m} of the sensor 1a in case of an error artificially induced in the sensor 1a. In FIG. 16a, the curves 161, 162, 163, 164 show the system imbalance in case of an artificially induced error of −1000 N, −400N, 400N and 1000N.

In FIG. 16b, the curves 171, 172, 173, 174 show the system imbalance in case of a factor of 1.4, 1.2, 0.8 and 0.6. The respective factor indicates the factor by which the actual value is multiplied and is incorrectly indicated by the load sensor 1a.

Hereinafter, it is explained as an example how the theoretical sensor values F_{1a_t}, F_{1b_t}, F_{2a_t}, F_{2b_t} which the load sensors 1a, 1b, 2a, 2b should issue at the load F_{ga_m} and the load center with the coordinates X_{a_m} and Y_{a_m} are calculated from the load F_{ga_m} determined by the load determination unit 104 and the load center with the coordinates X_{a_m} and Y_{a_m}.

For the load F_{ga_m} and the coordinates X_{a_m} and Y_{a_m} of the load center, the connections described above in equations (2) to (4) apply:

$${F}_{ga \_ m} = {F}_{1 a \_ m} + {F}_{1 b \_ m} + {F}_{2 a \_ m} + {F}_{2 b \_ m} \qquad ( 16 )$$

$${X}_{a \_ m} = \frac{{F}_{2 a \_ m} + {F}_{2 b \_ m}}{{F}_{ga \_ m}} a - \frac{a}{2} \qquad ( 17 )$$

$${Y}_{a \_ m} = \frac{b}{2} - \frac{{F}_{1 b \_ m} + {F}_{2 b \_ m}}{{F}_{ga \_ m}} b \qquad ( 18 )$$

The theoretical sensor values F_{1a_t}, F_{1b_t}, F_{2a_t}, F_{2b_t} are calculated as follows from the coordinates X_{a_m} and Y_{a_m} of the load center and the sensor values F_{1a_m}, F_{1b_m}, F_{2a_m}, F_{2b_m}:

$${F}_{1 a \_ t} = \frac{( {F}_{1 a \_ m} + {F}_{1 b \_ m} ) * ( {Y}_{a \_ m} + b / 2 )}{b} \qquad ( 19 )$$

$${F}_{1 b \_ t} = \frac{( {F}_{1 a \_ m} + {F}_{1 b \_ m} ) * ( {Y}_{a \_ m} - b / 2 )}{b} \qquad ( 20 )$$

$${F}_{2 a \_ t} = \frac{( {F}_{2 a \_ m} + {F}_{2 b \_ m} ) * ( {Y}_{a \_ m} + b / 2 )}{b} \qquad ( 21 )$$

$${F}_{2 b \_ t} = \frac{( {F}_{2 a \_ m} + {F}_{2 b \_ m} ) * ( {Y}_{a \_ m} - b / 2 )}{b} \qquad ( 22 )$$

The difference between the theoretical sensor values F_{1a_t}, F_{1b_t}, F_{2a_t}, F_{2b_t} and the respective measured sensor value F_{1a_m}, F_{1b_m}, F_{2a_m}, F_{2b_m} is identical for all load sensors 1a, 1b, 2a, 2b. This difference Δ can be determined as follows for the load sensor 1a, for example:

$$Δ = \vert {F}_{1 a \_ m} - {F}_{1 a \_ t} \vert \qquad ( 23 )$$

If the difference Δ is larger than a predetermined threshold value, e.g. 300 N, an error is determined, i.e. there is a system imbalance. If the difference Δ is smaller than the threshold value, the system works correctly.

In the following, example values for a system imbalance are indicated. For this, the load sensor 1a was charged with an error of 500 N.

### Measured Sensor Values:

$${F}_{1 a \_ m} = 3178 N$$

$${F}_{2 a \_ m} = - 1853 N$$

$${F}_{1 b \_ m} = 3099 N$$

$${F}_{2 b \_ m} = - 2238 N$$

### Calculated Load and Calculated Load Center:

$${F}_{ga \_ m} = 223 kg$$

$${X}_{a \_ m} = - 58 cm$$

$${Y}_{a \_ m} = 3 cm$$

### Calculated Theoretical Sensor Values:

$${F}_{1 a \_ t} = 3670 N$$

$${F}_{2 a \_ t} = - 2344 N$$

$${F}_{1 b \_ t} = 2607 N$$

$${F}_{2 b \_ t} = - 1747 N$$

Calculated difference Δ:

$$Δ ( {F}_{1 a} ) = 491 N$$

$$Δ ( {F}_{2 a} ) = - 4 \; 91 N$$

$$Δ ( {F}_{1 b} ) = - 4 \; 91 N$$

$$Δ ( {F}_{2 b} ) = 491 N$$

As the amount of the difference Δ is larger than a predetermined example threshold of 300 N, there is a system imbalance, i.e. the system does not work correctly.

Hereinafter, example values for a system working correctly are indicated for comparison. As opposed to the system working incorrectly above, here, no error of 500 N was added to the sensor value F_{1a_m}. The other sensor values F_{1b_m}, F_{2a_m}, F_{2b_m} correspond to the sensor values above.

### Measured Sensor Values:

$${F}_{1 a \_ m} = 2678 N$$

$${F}_{2 a \_ m} = - 1853 N$$

$${F}_{1 b \_ m} = 3099 N$$

$${F}_{2 b \_ m} = - 2238 N$$

### Calculated Load and Calculated Load Center:

$${F}_{ga \_ m} = 172 kg$$

$${X}_{a \_ m} = - 71 cm$$

$${Y}_{a \_ m} = 0 cm$$

### Calculated Theoretical Sensor Values:

$${F}_{1 a \_ t} = 2830 N$$

$${F}_{2 a \_ t} = - 2005 N$$

$${F}_{1 b \_ t} = 2947 N$$

$${F}_{2 b \_ t} = - 2 \; 086 N$$

### Calculated Difference Δ:

$$Δ ( {F}_{1 a} ) = 152 N$$

$$Δ ( {F}_{2 a} ) = - 152 N$$

$$Δ ( {F}_{1 b} ) = - 152 N$$

$$Δ ( {F}_{2 b} ) = 152 N$$

The difference Δ is smaller than the threshold value of 300 N. Therefore, the system works correctly.

Example embodiments and variants corresponding to the present disclosure are described in the following list of clauses and options:
Clause 1: A system (100, 200, 300) for detecting an error of a sensor in an operating table (10) and/or an error when determining a load or a load center, comprising:
   an operating table (10) with an adjustable patient bearing surface (18) for bearing a patient;
   a load sensor arrangement (102) with several load sensors (1a, 1b, 2a, 2b) which issue sensor values;
   a load determination unit (104) which determines at least one of the following first sizes with the sensor values: a load, a center of the load, a speed of the load center and an acceleration of the load center, wherein the load is a load acting on the load sensor arrangement (102) or a load acting on the operating table (10) or a total load of the operating table (10);
   a calculation unit (117) which predicts or calculates at least one expected second size; and
   an error recognition unit (118) which compares the sensor values or the at least one first size with the at least one expected second size and, if the deviation exceeds a predetermined value, detects an error and/or a possible error.
Clause 2: The system (100, 200) according to clause 1, wherein
   the calculation unit (117), when the patient bearing surface (18) is adjusted, predicts the load center changed by the adjustment as the at least one second size,
   the load determination unit (104) determines at least the load center as the at least one first size after adjusting the patient bearing surface (18) with the sensor values, and
   the error recognition unit (118) compares the load center predicted by the calculation unit (117) with the load center determined by the load determination unit (104) and, if the deviation exceeds the predetermined value, detects an error and/or a possible error.
Clause 3: The system (100, 200) according to clause 2, further comprising a condition estimation unit (119) which estimates an actual load center with the load center predicted by the calculation unit (117) and the load center determined by the load determination unit (104), wherein the condition estimation unit (119) estimates the actual load center in particular with a weighted value of the load center predicted by the calculation unit (117) and with a weighted value of the load center determined by the load determination unit (104).
Clause 4: The system (100, 200) according to clause 3, wherein the condition estimation unit (119) has a Kalman filter for estimating the actual load center.
Clause 5: The system (100, 200) according to clause 1, wherein the calculation unit (117), the load determination unit (104) and a condition estimation unit (119) work iteratively by the calculation unit (117) predicting the load center at the time t+1 as the at least one second size with an actual load center at the time t estimated by the condition estimation unit (119), the load determination unit (104) determining the load center at the time t+1 as the at least one first size and the condition estimation unit (119) then estimating the actual load center at the time t+1 with the load center at the time t+1 determined by the calculation unit (117) and the load center at the time t+1 determined by the load determination unit (104).
Clause 6: The system (100, 200) according to clause 5, wherein the error recognition unit (119) detects an error and/or a possible error if the load center predicted by the calculation unit (117) and the load center determined by the load determination unit (104) exceed a respective predetermined deviation in at least a predetermined number of iterations.
Clause 7: The system (100, 200) according to clause 5, wherein the error recognition unit (119) detects an error and/or a possible error if the load center predicted by the calculation unit (117) and the load center determined by the load determination unit (104) exceed a predetermined deviation in at least one of the iterations.
Clause 8: The system (100, 200) according to clause 1, wherein
   the calculation unit (117), when the patient bearing surface (18) is adjusted, predicts the speed or the acceleration of the load center as the at least one second size,
   the load determination unit (104) determines at least the speed or the acceleration of the load center as the at least one first size after adjusting the patient bearing surface (18) with the sensor values, and
   the error recognition unit (118) compares the speed or acceleration of the load center predicted by the calculation unit (117) with the speed or acceleration of the load center determined by the load determination unit (104) and, if the deviation exceeds the predetermined value, detects an error and/or a possible error.
Clause 9: The system (100, 200) according to clause 8, further comprising a condition estimation unit (119) which estimates an actual speed or acceleration of the load center with the speed or acceleration of the load center predicted by the calculation unit (117) and the speed or acceleration of the load center determined by the load determination unit (104).
Clause 10: The system (100, 200) according to clause 9, wherein the condition estimation unit (119) has a Kalman filter for estimating the actual speed or acceleration of the load center.
Clause 11: The system (100, 200) according to clause 1, wherein the calculation unit (117), the load determination unit (104) and a condition estimation unit (119) work iteratively by the calculation unit (117) predicting the speed or acceleration of the load center at the time t+1 as the at least one second size with an actual speed or acceleration of the load center at the time t estimated by the condition estimation unit (119), the load determination unit (104) determining the speed or acceleration of the load center at the time t+1 as the at least one first size and the condition estimation unit (119) then estimating the actual speed or acceleration of the load center at the time t+1 with the speed or acceleration of the load center at the time t+1 predicted by the calculation unit (117) and the speed or acceleration of the load center at the time t+1 determined by the load determination unit (104).
Clause 12: The system (100, 200) according to clause 11, wherein the error recognition unit (118) detects an error and/or a possible error if the speed or acceleration of the load center predicted by the calculation unit (117) and the speed or acceleration of the load center determined by the load determination unit (104) each exceed a predetermined deviation in at least a predetermined number of iterations.
Clause 13: The system (100, 200) according to clause 11, wherein the error recognition unit detects an error and/or a possible error if the speed or acceleration of the load center predicted by the calculation unit (117) and the speed or acceleration of the load center determined by the load determination unit (104) exceed a predetermined deviation in at least one of the iterations.
Clause 14: The system (100, 300) according to clause 1, wherein
   the load determination unit (104) determines the load and/or the load center as the first sizes with the sensor values,
   the calculation unit (117) calculates theoretical sensor values as the second sizes, wherein the theoretical sensor values are those sensor values the load sensors (1a, 1b, 2a, 2b) should issue at the load determined
   by the load determination unit (104) and/or the load center, and the error recognition unit (118) compares the sensor values issued by the load sensors (1a, 1b, 2a, 2b) with the theoretical sensor values calculated by the calculation unit (117) and, if the deviation exceeds the predetermined value, detects an error and/or a possible error.
Clause 15: The system (100, 300) according to clause 14, wherein the error recognition unit (118) is able to detect an error and/or a possible error if the patient bearing surface (18) is not adjusted.
Clause 16: The system (100, 300) according to any one of the preceding clauses, wherein the load sensor arrangement (102) has at least three load sensors or at least four load sensors (1a, 1b, 2a, 2b).
Clause 17: The system (100, 300) according to any one of the preceding clauses, wherein the several load sensors (1a, 1b, 2a, 2b) are arranged in a single common plane.
Clause 18: The system (100, 300) according to any one of the preceding clauses, wherein several ones of the load sensors (1a, 1b, 2a, 2b) are arranged mirror-symmetrically with regard to a first axis (210) and mirror-symmetrically with regard to a second axis (212), and
   wherein the first and the second axis (210, 212) are aligned orthogonally to one another.
Clause 19: The system (100) according to any one of the preceding clauses, wherein the error recognition unit (118) detects a possible error of at least one of the load sensors (1a, 1b, 2a, 2b) if the load determined by the load determination unit (104) is negative.
Clause 20: The system (100) according to any one of the preceding clauses, wherein the error recognition unit (118) detects an error and/or a possible error of at least one of the load sensors (1a, 1b, 2a, 2b) if the load determined by the load determination unit (104) exceeds a predetermined value and/or the load center determined by the load determination unit (104) lies outside a predetermined space.
Clause 21: The system (100) according to any one of the preceding clauses, wherein the error recognition unit (118) detects an error and/or a possible error of one of the load sensors (1a, 1b, 2a, 2b) if the load sensor does not change its sensor value while the other load sensors change their sensor values or if the load sensor changes its sensor value while the other load sensors do not change their sensor values.
Clause 22: The system (100) according to any one of the preceding clauses, wherein the error recognition unit (118) detects an error and/or a possible error of one of the load sensors (1a, 1b, 2a, 2b) if the load F_{measured} determined by the load determination unit (104) does not follow the following equation in case of a trend and/or tilt of the patient bearing surface (18):

$${F}_{measured} = {F}_{load} \cdot cos α - ( 1 - cos α ) \cdot {F}_{dl} ,$$

wherein F_{load} is a load acting on the patient bearing surface (18), α is the trend and/or tilt angle of the patient bearing surface (18) and F_{dl} is a tared load which comprises all loads which are part of the operating table (10) and are above the load sensors (1a, 1b, 2a, 2b).
Clause 23: The system (100) according to any one of the preceding clauses, wherein the adjusting of the patient bearing surface (18) comprises one or more of the following operations: trending the patient bearing surface (18), tilting the patient bearing surface (18), longitudinally displacing the patient bearing surface (18), laterally displacing the patient bearing surface (18) and laterally displacing the patient bearing surface (18).
Clause 24: The system (100) according to any one of the preceding clauses, wherein a sensor error is an error of one or more of the following sensors: load sensors (1a, 1b, 2a, 2b), sensors for detecting the trend of the patient bearing surface (18), sensors for detecting the tilt of the patient bearing surface (18), sensors for detecting the longitudinal displacement of the patient bearing surface (18), sensors for detecting the lateral displacement of the patient bearing surface (18) and column lift sensors.
Clause 25: The system (100) according to any one of the preceding clauses, wherein the error recognition unit (118) upon detecting an error and/or a possible error creates an error signal so that it indicates a safety-critical condition of the operating table (10), an acoustic and/or optical warning signal and/or a warning signal in text form are created and/or a movement of the operating table (10) is slowed down or stopped and/or at least one function of the operating table (10) is blocked.
Clause 26: The system (100) according to any one of the preceding clauses, wherein the calculation unit (117) predicts the at least one expected second size.
Clause 27: A method for detecting an error of a sensor in an operating table (10) and/or an error when determining a load or a load center, wherein
   the operating table (10) has an adjustable patient bearing surface (18) for bearing a patient and a load sensor arrangement (102) with several load sensors (1a, 1b, 2a, 2b) which issue sensor values;
   with the sensor values, at least one of the following first sizes is determined: a load, a center of the load, a speed of the load center and an acceleration of the load center, wherein the load is a load acting on the load sensor arrangement (102) or a load acting on the operating table (10) or a total load of the operating table (10);
   at least one expected second size is predicted or calculated; and
   the sensor values or the at least one first size is compared with the at least one expected second size and, if the deviation exceeds a predetermined value, an error is detected.
Clause 28: The method according to clause 27, wherein
   if the patient bearing surface (18) is adjusted, the load center changed by the adjustment is predicted as the at least one second size,
   at least the load center is determined as the at least one first size after adjusting the patient bearing surface (18) with the sensor values, and the predicted load center is compared with the determined load center and, if the deviation exceeds the predetermined value, an error is detected.
Clause 29: The method according to clause 27, wherein
   the load and/or the load center are determined as the first sizes with the sensor values,
   theoretical sensor values are calculated as the second sizes, wherein the theoretical sensor values are those sensor values the load sensors (1a, 1b, 2a, 2b) should issue at the determined load and/or the determined load center, and
   the sensor values issued by the load sensors (1a, 1b, 2a, 2b) are compared with the theoretical sensor values calculated by the calculation unit (117) and, if the deviation exceeds the predetermined value, an error is detected.
Clause 30: A system (100) for detecting an error of a sensor in an operating table (10), comprising:
   an operating table (10) with an adjustable patient bearing surface (18) for bearing a patient;
   a load sensor arrangement (102) with several load sensors (1a, 1b, 2a, 2b) which issue sensor values;
   a load determination unit (104) which determines at least one load with the sensor values, wherein the load is a load acting on the load sensor arrangement (102) or a load acting on the operating table (10) or a total load of the operating table (10); and
   an error recognition unit (118) which detects a possible error of at least one of the load sensors (1a, 1b, 2a, 2b) if the load determined by the load determination unit (104) is negative.
Clause 31: A system (100) for detecting an error of a sensor in an operating table (10), comprising:
   an operating table (10) with an adjustable patient bearing surface (18) for bearing a patient;
   a load sensor arrangement (102) with several load sensors (1a, 1b, 2a, 2b) which issue sensor values;
   a load determination unit (104) which determines at least one load and/or a center of the load with the sensor values, wherein the load is a load acting on the load sensor arrangement (102) or a load acting on the operating table (10) or a total load of the operating table (10); and an error recognition unit (118) which detects an error and/or a possible error of at least one of the load sensors (1a, 1b, 2a, 2b) if the load determined by the load determination unit (104) exceeds a predetermined value and/or the load center determined by the load determination unit (104) lies outside a predetermined space.
Clause 32: A system (100) for detecting an error of a sensor in an operating table (10), comprising:
   an operating table (10) with an in particular adjustable patient bearing surface (18) for bearing a patient;
   a load sensor arrangement (102) with several load sensors (1a, 1b, 2a, 2b) which issue sensor values; and
   an error recognition unit (118) which detects an error and/or a possible error of one of the load sensors (1a, 1b, 2a, 2b) if the load sensor does not change its sensor value while the other load sensors change their sensor values or if the load sensor changes its sensor value while the other load sensors do not change their sensor values.
Clause 33: A system (100) for detecting an error of a sensor in an operating table (10), comprising:
   an operating table (10) with an adjustable patient bearing surface (18) for bearing a patient;
   a load sensor arrangement (102) with several load sensors (1a, 1b, 2a, 2b) which issue sensor values;
   a load determination unit (104) which determines at least one load with the sensor values, wherein the load is a load acting on the load sensor arrangement (102) or a load acting on the operating table (10) or a total load of the operating table (10); and
   an error recognition unit (118) which detects an error and/or a possible error of one of the load sensors (1a, 1b, 2a, 2b) if the load F_{measured} determined by the load determination unit (104) does not follow the following equation in case of a trend and/or tilt of the patient bearing surface (18):

$${F}_{measured} = {F}_{g} \cdot cos α - ( 1 - cos α ) \cdot {F}_{dl} ,$$

wherein F_{g} is a load acting on the patient bearing surface (18), α is the trend and/or tilt angle of the patient bearing surface (18) and F_{dl} is a tared load which comprises all loads which are part of the operating table (10) and are above the load sensors (1a, 1b, 2a, 2b).

1-27. (canceled)

28. A system for detecting an error of a sensor in an operating table or detecting an error when determining a load or a load center of the operating table, the system comprising:
the operating table having an adjustable patient bearing surface for bearing a patient;
a load sensor arrangement comprising a plurality of load sensors configured to issue sensor values;
a load determination unit configured to determine at least one first parameter using the sensor values after adjusting the patient bearing surface, the at least one first parameter being selected from: a load center, a speed of the load center, or an acceleration of the load center,
the load center being a center of a load, the load being a load acting on the load sensor arrangement, a load acting on the operating table, or a total load of the operating table;
a calculation unit configured to predict or calculate at least one expected second parameter when the patient bearing surface is adjusted, the at least one expected second parameter being selected from:
the load center changed by the adjustment, or
the speed of the load center, or
the acceleration of the load center; and
an error recognition unit configured to compare the at least one expected second parameter predicted or calculated by the calculation unit with the at least one first parameter determined by the load determination unit to determine a deviation, and if the deviation exceeds a predetermined value the error recognition unit detects an error or possible error.

29. The system according to claim 28, further comprising a condition estimation unit configured to estimate:
an actual load center using the load center as the at least one expected second parameter predicted by the calculation unit and the load center as the at least one first parameter determined by the load determination unit, wherein the condition estimation unit is configured to estimate the actual load center using a weighted value of the load center predicted by the calculation unit and a weighted value of the load center determined by the load determination unit; or
an actual speed or acceleration of the load center using the speed or the acceleration of the load center as the at least one expected second parameter predicted by the calculation unit and the speed or the acceleration of the load center as the at least one first parameter determined by the load determination unit.

30. The system according to claim 29, wherein the condition estimation unit comprises a Kalman filter configured for:
estimating the actual load center; or
the actual speed or acceleration of the load center.

31. The system according to claim 1, wherein the calculation unit, the load determination unit, and a condition estimation unit are configured to work iteratively by the calculation unit to predict the load center at the time t+1 as the at least one expected second parameter with an actual load center at the time t being estimated by the condition estimation unit, the load determination unit being configured to determine the load center at the time t+1 as the at least one first parameter and the condition estimation unit configured to then estimate the actual load center at the time t+1 using the load center at the time t+1 determined by the calculation unit and the load center at the time t+1 determined by the load determination unit.

32. The system according to claim 31, wherein the error recognition unit is configured to detect an error or a possible error if the load center predicted by the calculation unit and the load center determined by the load determination unit exceed a predetermined deviation in a predetermined number of iterations.

33. The system according to claim 31, wherein the error recognition unit is configured to detect an error or a possible error if the load center predicted by the calculation unit and the load center determined by the load determination unit exceed a predetermined deviation in at least one of the iterations.

34. The system according to claim 28, wherein the calculation unit, the load determination unit, and a condition estimation unit are configured to work iteratively by the calculation unit to predict the speed or the acceleration of the load center at the time t+1 as the at least one expected second parameter with an actual speed or acceleration of the load center at the time t being estimated by the condition estimation unit, the load determination unit configured to determine the speed or acceleration of the load center at the time t+1 as the at least one first parameter and the condition estimation unit configured to then estimate the actual speed or acceleration of the load center at the time t+1 using the speed or acceleration of the load center at the time t+1 predicted by the calculation unit and the speed or acceleration of the load center at the time t+1 determined by the load determination unit.

35. The system according to claim 34, wherein the error recognition unit is configured to detect an error or a possible error if the speed or the acceleration of the load center predicted by the calculation unit and the speed or acceleration of the load center determined by the load determination unit each exceed a predetermined deviation in a predetermined number of iterations.

36. The system according to claim 34, wherein the error recognition unit is configured to detect an error or a possible error if the speed or the acceleration of the load center predicted by the calculation unit and the speed or the acceleration of the load center determined by the load determination unit exceed a predetermined deviation in at least one of the iterations.

37. A system for detecting an error of a sensor in an operating table or detecting an error when determining a load or a load center of the operating table, the system comprising:
the operating table having an adjustable patient bearing surface for bearing a patient;
a load sensor arrangement comprising a plurality of load sensors configured to issue sensor values;
a load determination unit configured to determine at least one first parameter using the sensor values, the at least one first parameter being selected from: a load, or a load center,
the load being a load acting on the load sensor arrangement, a load acting on the operating table, or a total load of the operating table;
a calculation unit configured to predict or calculate an expected second parameter, the expected second parameter being theoretical sensor values, the theoretical sensor values comprising expected sensor values that the plurality of load sensors are predicted or calculated to issue based on the load or load center as the first parameter determined by the load determination unit; and
an error recognition unit configured to compare the sensor values issued by the plurality of load sensors with the theoretical sensor values as the expected second parameter calculated or predicted by the calculation unit to determine a deviation, and if the deviation exceeds a predetermined value the error recognition unit detects an error or possible error.

38. The system according to claim 37, wherein the error recognition unit is configured to detect an error or a possible error if the patient bearing surface is not adjusted.

39. The system according to claim 28, wherein the load sensor arrangement has at least three load sensors.

40. The system according to claim 28, wherein the plurality of load sensors is arranged in a single common plane.

41. The system according to claim 28, wherein some of the plurality of load sensors are arranged mirror-symmetrically with regard to a first axis and mirror-symmetrically with regard to a second axis, and wherein the first axis and the second axis are aligned orthogonally to one another.

42. The system according to claim 28, wherein the error recognition unit is configured to detect an error or a possible error of at least one of the load sensors if the load determined by the load determination unit as the at least one first parameter exceeds a predetermined value or if the load center determined by the load determination unit as the first parameter lies outside a predetermined space.

43. A system for detecting an error of a sensor in an operating table or detecting an error when determining a load or a load center of the operating table, the system comprising:
the operating table having an adjustable patient bearing surface for bearing a patient;
a load sensor arrangement comprising a plurality of load sensors configured to issue sensor values;
a load determination unit configured to determine at least one first parameter using the sensor values, the at least one first parameter being selected from: a load, a load center, a speed of the load center, or an acceleration of the load center,
the load center being a center of a load, the load being a load acting on the load sensor arrangement, a load acting on the operating table, or a total load of the operating table;
a calculation unit configured to predict or calculate at least one expected second parameter, the at least one expected second parameter being selected from: the load, the load center, the speed of the load center, the acceleration of the load center, or theoretical sensor values,
the theoretical sensor values comprising expected sensor values that the plurality of load sensors is predicted or calculated to issue based on the load or load center as the first parameter determined by the load determination unit; and
an error recognition unit configured to compare the at least one expected second parameter predicted or calculated by the calculation unit with the at least one first parameter determined by the load determination unit, the error recognition unit configured to detect an error or possible error of one or more of the load sensors if:
the load determined by the load determination unit is negative, or
the load sensor does not change its sensor value while the other load sensors change their sensor values, or
the load sensor changes its sensor value while the other load sensors do not change their sensor values, or
the load F_{measured} determined by the load determination unit does not follow the following equation in case of a trend and/or tilt of the patient bearing surface:
$${F}_{measured} = {F}_{load} \cdot cos α - ( 1 - cos α ) \cdot {F}_{dl} ,$$
wherein F_{load} is the load acting on the patient bearing surface, r is the trend and/or tilt angle of the patient bearing surface, and P, is a tared load which comprises all loads which are part of the operating table and are above the load sensors.

44. The system according to claim 28, wherein the adjusting of the patient bearing surface comprises one or more of:
trending the patient bearing surface,
tilting the patient bearing surface,
longitudinally displacing the patient bearing surface, or
laterally displacing the patient bearing surface.

45. The system according to claim 28, wherein the error or possible error comprises a sensor error of one or more of the following sensors:
the plurality of load sensors,
sensors for detecting a trend of the patient bearing surface,
sensors for detecting a tilt of the patient bearing surface,
sensors for detecting a longitudinal displacement of the patient bearing surface,
sensors for detecting a lateral displacement of the patient bearing surface, or column lift sensors.

46. The system according to claim 28, wherein the error recognition unit upon detection of an error or a possible error creates an error signal that indicates a safety-critical condition of the operating table, an acoustic or optical warning signal or a warning signal in text form are created or a movement of the operating table is slowed down or stopped or at least one function of the operating table is blocked.

47. The system according to claim 28, wherein the calculation unit predicts the at least one expected second parameter.

48. A method for detecting an error of a sensor in an operating table or an error when determining a load or a load center using the system of claim 28, the method comprising:
after adjusting the patient bearing surface, determining the at least one first parameter using the load determination unit;
calculating or predicting the at least one expected second parameter using the calculation unit; and
using the error recognition unit to compare the sensor values or the at least one first parameter with the at least one expected second parameter to determine a deviation, the error recognition unit detecting an error or possible error if the deviation exceeds a predetermined value.
